(19) United States
(12) Patent Application Publication
(10) Pub. No.: US 2010/0265326 A1
(43) Pub. Date: Oct. 21, 2010

(54) Sensory enhancement method and system for visual media

(76) Inventor: Kevin A. Kujala, Elgin, IL (US)

Correspondence Address: MERONI + MERONI, P.O. BOX 309, BARRINGTON, IL, 60011, US

(21) Appl. No.: 12/386,547

(22) Filed: Apr. 20, 2009

(51) Int. Cl. G09B 9/00

(52) U.S. Cl. 348/121

(57) ABSTRACT

A sensory enhancement method and system for visual media provides a user with additional sensory information associated with visual events displayed upon a view screen. The system comprises a sensory-information-delivery chamber, at least one air source, and central processing machinery. The chamber comprises a framework, vent assemblies, a support platform, and a view screen. The framework comprises a series of interconnected air ducts. The vent assemblies are operably connected to the air ducts. The view screen displays visual events inherently associated with air movement. The vent assemblies comprise air outlets that direct moving air toward the user for providing the user with tactile sensory information. The central processing machinery is operably connected to the view screen and the air sources for selectively displaying the visual events and for selectively directing air against the user in simultaneous occurrence with the visual events display for delivering a coordinated visual-tactile sensation.

### BACKGROUND OF THE INVENTION

1. Field of the Invention

The present invention generally relates to a method and system for delivering tactile feedback through sensory integration for visual media such as video games, theatrical cinema, and theatrical productions.

2. Description of the Prior Art

Enthusiasts of video or other electronically-generated visual imagery continually seek to improve or enhance the entertainment value of the electronically-generated visual experience by attempting to improve upon the realism of the visual imagery. The prior art is replete with examples of apparatus and systems for generally enhancing visual sensory information as delivered to the viewer by a view screen. A relatively common technique for enhancing or bolstering the visual experience is to deliver other sensory information to the viewer, which other sensory information is typically inherently associated with the visual imagery. Several of the more pertinent prior art patent disclosures that have attempted to couple non-visual sensory information with visual sensory information in an attempt to otherwise improve upon the realism of visual experiences are described briefly hereinafter.

U.S. Pat. No. 5,388,991 ('991 patent), which issued to Morris, discloses a Simulation Device and System. The '991 patent teaches a simulator device which incorporates a full 360 degree axial roll to a passenger capsule. The device also provides 70 degrees of pitch to the capsule. The simulator device thus provides the passenger with 0.5 G's pitch forward, 0.25 G's pitch backward, 0.25 G's rotational acceleration, and 0.25 G's vertical acceleration. These forces simulate the motion sensations of high speed loop roller coasters, bobsled rides, water rides, flying rides, and driving rides. In one embodiment of the present invention, a visual and audio system provides high resolution images and stereo sound to create realistic sensory experiences. The '991 patent further teaches interior air flow controlled by a conventional air-flow/conditioning system. Notably, the constant air flow is independent of capsule rotation.

U.S. Pat. No. 5,490,784 ('784 patent) and U.S. Pat. No. 5,980,256 ('256 patent), both of which issued to Carmein, disclose versions of a Virtual Reality System with Enhanced Sensory Apparatus. The '784 patent teaches motion simulating device which is capable of creating motion with up to six degrees of freedom; three rotational degrees of freedom and three translational degrees of freedom. The motion simulating device includes a generally spherical capsule supported on a plurality of rollers that are connected to a translatable frame. At least one of the rollers is a multi-directional active roller that frictionally engages the capsule to impart rotational motion in any direction. The frame is optionally attached to a number of actuator legs which are capable of translating sounds and physical sensations which may be electronically coordinated and reproduced in the capsule so that a user may interactively control and respond to a variety of environments while simultaneously experiencing the corresponding motion and physical sensations associated with the interactive environment. Notably, the '784 patent further teaches other means for stimulating a user's senses such as smell, taste, and temperature. See generally Column No. 15, Line Nos. 40-44.

U.S. Pat. No. 5,547,382 ('382 patent), which issued to Yamasaki et al., discloses a Riding Simulation System for Motorcycles. The '382 patent teaches a model motorcycle operated and ridden upon by a person. Responsive to operation by the person riding, the model motorcycle is moved by a driven mount to pitch, yaw and roll to simulate riding conditions. A moving image such as scenery, which would be seen from a running motorcycle, is displayed in front of the person riding. The moving image is varied in response to driving conditions of the model motorcycle and is provided by a display with a curved screen from behind. The system is provided with an image recorder for recording both images displayed by the display and driving operation data. Notably, the '382 patent contemplates fans for the supply of wind and for thereby imparting a drive feeling to the rider.

U.S. Pat. No. 5,759,044 ('044 patent), which issued to Redmond, discloses Methods and Apparatus for Generating and Processing Synthetic and Absolute Real Time Environments. The '044 patent teaches a system for generating and processing synthetic and absolute real time remote environments for interaction with a user and his or her biological senses, which comprises seven modules. The user stimuli module, in a preferred embodiment, includes components for enhanced tactile input. A three dimensional chamber is adapted to simulate gross environmental conditions such as smells, sonic rumbling, variable temperature and variable wind velocity. The chamber is equipped with a rectangular matrix of rods, which can be arranged with their longitudinal axis perpendicular to the chamber wall, or in a stand along unit inside the chamber. The rods are electromechanically manipulated to generate shapes and textures for interaction with the system user. In another embodiment, the user is provided with boot shaving bladders which can be inflated and deflated to change the user's perception of the chamber surface. In the preferred embodiment, the chamber is equipped with enhancements such as air jet streams which provide users with stimuli to simulate forward and backward motion. Sonic resonators may also be installed to relax a user's brain functions and increase susceptibility to the synthesized environmental modeling output. Temperature variations can be effected by regulating chamber temperature, or modifying the temperature inside the user's suit.

From an inspection of these patent disclosures and other art generally known in the relevant art, it will be seen that the prior art does not teach a sensory enhancement method and system for visual media, which system provides users with tactile and/or auditory sensory information otherwise inherently associated with certain visual events displayed upon a view screen, which sensory enhancement method and system for visual media comprises, in combination at least one sensory-information-delivery structure or chamber, forced air means, compressed air means, and central processing means. More particularly, it will be seen that the prior art patent disclosures do not teach a sensory-information-delivery structure or chamber comprising duct means, vent means, a substantially planar view wall, and at least four corner regions, which corner regions include two superior corners and two inferior corners wherein the duct means interconnect the corner regions and the vent means are operably connected to the duct means at the corner regions and at least one location intermediate the corner regions.

It will be further seen that the prior art does not teach a sensory enhancement method and system for visual media wherein the view wall extends intermediate the superior corners and the inferior corners and comprises visual image display means for displaying visual images to a visual event viewer (the visual images comprising visual events inherently associated with air movement) who is positioned in a viewer-locating region intermediate the corner regions. The prior art patent disclosures further do not teach vent means comprising air outlet means designed to direct moving air toward the viewer-locating region and thus against the visual event viewer, which moving air is selectively directed by central processing means to contact the visual event viewer in simultaneous occurrence with the display of certain visual events to thus deliver a coordinated visual-tactile sensation for providing the visual image viewer with sensory information otherwise inherently associated with the visual events.

### SUMMARY OF THE INVENTION

It is a primary object of the present invention to provide a method of enhancement to visual media through sensory integration, including, but not limited to sight, sound, and touch/contact, resulting in a more immersive and enriching experience of the visual media. Certain visual events are typically inherently associated with other types of sensory information such as tactile and/or auditory sensory information. A common example in this regard is an explosion. An actual explosion involves certain drastic visual imagery typically including change of color, shapes, and fields of view. Inherently associated with the visual imagery are certain tactile sensations such as a rush of heated wind or heated air currents, impact waveforms, and flying debris, all of which may impact upon tactile receptors of passersby. Further, certain high decibel audible information is inherently associated with explosive activity provided the regions surrounding the explosion comprise some medium through which the sound waves may travel. Thus, it is a further object of the present invention to couple certain sensory information to the visual sensory information otherwise typically associated with the visual events so as to enhance the realism of the visual event. In this regard, it is an object of the present invention to sensory-information-delivery system that coordinates tactile and/or auditory sensory information with visual events displayed upon a view screen.

To achieve these and other readily apparent objectives, the present invention provides a sensory enhancement method and system for visual media for providing a visual event viewer with additional sensory information otherwise inherently associated with visual events displayed upon a view screen, which sensory enhancement method and system for visual media comprises, in combination, a sensory-information-delivery chamber, forced air means, compressed air means, and central processing means. The sensory-information-delivery chamber essentially comprises a substantially cubic framework, a plurality of corner vent assemblies, a plurality of intermediary vent assemblies, a substantially planar viewer support platform, a substantially planar view wall, and a viewer-locating region. Being essentially cubic in design, the chamber inherently comprises eight corner regions, including four superior corners and four inferior corners. The cubic framework comprises a series of interconnected air ducts, which interconnect the corner regions. The corner vent assemblies are operably connected to the air ducts at the corner regions and the intermediary vent assemblies are operably connected to the air ducts intermediate the corner regions.

The viewer support platform extends intermediate the inferior corners and the view wall extends intermediate two of the superior corners and two of the inferior corners. Notably, the view wall comprises visual image display means for displaying visual images to a visual event viewer. The visual images comprise certain visual events that are inherently associated with air movement. The viewer support platform is designed to support a visual event viewer positioned in the viewer-locating region, which region may be defined by a substantially uniform radial distance extending from the intersection of two vertically-oriented planes diagonally extending through opposite corner regions.

The corner vent assemblies and the intermediary vent assemblies each essentially comprise forced air outlet means and compressed air outlet means, which air outlet means direct moving air toward the viewer-locating region for providing the visual event viewer with tactile (moving air) sensory information. The forced air means are operably connected to the air ducts for selectively directing forced air through the air ducts and the forced air outlet means. The compressed air means are operably connected to the air ducts for selectively directing compressed air through the air ducts and the compressed air outlet means.

The central processing means are operably connected to the visual image display means, the forced air means, and the compressed air means for selectively displaying the visual events and for selectively directing the forced air means and compressed air means to direct air toward the viewer-locating region in simultaneous occurrence with the display of the visual events for delivering a coordinated visual-tactile sensation. The coordinated visual-tactile sensation provides the visual event viewer with additional sensory information otherwise inherently associated with the visual events.

The forced air means and the compressed air means may comprise air heating-cooling means for selectively heating-cooling the air directed toward the viewer-locating region. The air heating-cooling means is thus designed to form a heated-cooled, visual-tactile sensation. Further, the sensory enhancement method and system for visual media may comprise audio-delivery means operably connected to the central processing means. In this regard, the central processing means selectively delivers auditory sensory information (via the audio-delivery means) inherently associated with the visual events. Thus, the audio-delivery means is designed to form a coordinated visual-auditory sensation.

The vent means may be defined by a plurality of vent assemblies, each comprising a substantially conical outer vent shell and a centrally-located inner vent nozzle. Each outer vent shell comprises a fixed upper air diversion portion, a movable lower air diversion portion, a vertex region, and gate-operating means. The gate-operating means is located at the vertex region and is operably connected to the central processing means and lower air diversion portion. The central processing means selectively directs the gate-operating means to hingedly move the lower air diversion portion from a fully closed state to a fully open state for diverting select amounts of forced air against the upper air diversion portion, the upper air diversion portion for directing forced air toward the viewer-locating region.

The compressed-air hoses terminate at the centrally-located inner vent nozzles, which centrally-located inner vent nozzles each comprise valve means. The valve means are operably connected to the central processing means. The central processing means selectively operates or actuates the valve means between a fully closed state and a fully open state for diverting select amounts of compressed air toward the viewer-locating region.

Other objects of the present invention, as well as particular features, elements, and advantages thereof, will be elucidated in, or apparent from, the following description and the accompanying drawing figures.

### BRIEF DESCRIPTION OF THE DRAWINGS

Other features of my invention will become more evident from a consideration of the following brief description of patent drawings, as follows:

FIG. 1 is a plan view of the view screen wall of the sensory-information-delivery chamber showing the view screen, ductwork, and a plurality of vent assemblies.

FIG. 2 is a plan view of the left vertical region of the sensory-information-delivery chamber showing a right edge view of the view screen, ductwork and a plurality of vent assemblies.

FIG. 3 is a plan view of the right vertical region of the sensory-information-delivery chamber showing a left edge view of the view screen, ductwork and a plurality of vent assemblies.

FIG. 4 is a plan view of the rear vertical region of the sensory-information-delivery chamber showing a rear-mounted door, ductwork, and a plurality of vent assemblies.

FIG. 5 is a top plan view of the sensory-information-delivery chamber showing the top edge view of the view screen, ductwork, the viewer support platform, and a plurality of vent assemblies.

FIG. 6 is a top plan view of the support platform showing a view region support grid, a single vent assembly, and the top edge view of the view screen.

FIG. 6(a) is a top plan view of an alternative embodiment of the support platform showing a view region support grid, a plurality of vent assemblies, and a top edge view of the view screen.

FIG. 7 is a perspective view of the sensory-information-delivery chamber, showing a substantially cubic framework, ductwork, corner vent assemblies, intermediary vent assemblies, a substantially planar support platform, and a substantially planar view wall.

FIG. 8 is a perspective view of a dual sensory-information-delivery chamber showing dual, side-by-side, substantially cubic frameworks, ductwork, corner vent assemblies, intermediary vent assemblies, substantially planar support platform structure, and substantially planar view wall structure.

FIG. 9 is a fragmentary cross-sectional side view of a vertical air duct showing two corner vent assemblies and a single intermediary vent assembly.

FIG. 10 is a fragmentary cross-sectional side view of a vertical air duct showing a single vent assembly.

FIG. 11 is a front plan view of an alternative embodiment of the sensory enhancement method and system for visual media.

FIG. 12(a) is a first schematic depiction of the compressed air means, showing a compressor, compressed air lines, and a plurality of compressed air outlet nozzles.

FIG. 12(b) is a second schematic depiction of the compressed air means, showing a compressor, compressed air lines, and a plurality of compressed air outlet nozzles.

FIG. 12(c) is a third schematic depiction of the compressed air means, showing a compressor, compressed air lines, and a plurality of compressed air outlet nozzles.

FIG. 12(d) is a fourth schematic depiction of the compressed air means, showing a compressor, compressed air lines, and a plurality of compressed air outlet nozzles.

FIG. 12(e) is a fifth schematic depiction of the compressed air means, showing a compressor, compressed air lines, and a plurality of compressed air outlet nozzles.

FIG. 12(f) is a sixth schematic depiction of the compressed air means, showing a compressor, compressed air lines, and a plurality of compressed air outlet nozzles.

FIG. 13(a) is a first schematic depiction of the forced air means, showing a fan, forced air lines, and a plurality of forced air outlet vents.

FIG. 13(b) is a second schematic depiction of the forced air means, showing a fan, forced air lines, and a plurality of forced air outlet vents.

FIG. 13(c) is a third schematic depiction of the forced air means, showing a fan, forced air lines, and a plurality of forced air outlet vents.

FIG. 13(d) is a fourth schematic depiction of the forced air means, showing a fan, forced air lines, and a plurality of forced air outlet vents.

FIG. 14 is a perspective view of the preferred embodiment of the sensory enhancement method and system for visual media, schematically depicting central processing means, compressed air means and forced air means operably connected to the sensory-information-delivery chamber.

FIG. 15 is a plan view of the view screen wall depicting a visual image upon the view screen comprising a visual event inherently associated with air movement and a plurality of vent assemblies directing moving air toward the viewer-locating region.

### DETAILED DESCRIPTION OF THE PREFERRED EMBODIMENT

Referring now to the drawings, the preferred embodiment of the present invention generally concerns a system for enhancing the realism of visual events as displayed upon a view screen or other visual image display means. It is contemplated that the enhancement of visual event realism may be achieved by the introduction or delivery of certain sensory information that would otherwise be inherently associated with the visual events as they are displayed upon a view screen or other visual image display means. For example, an explosion (as generally depicted in FIG. 15) is visually stimulating in that it comprises a drastic change in color schemes as well as drastic change in shapes and sizes of the exploding media, and other field of view images. Inherently associated with an explosion is a dramatic release of thermal energy heat and violent air movement. Visual event viewers of explosions as displayed upon visual image display means are typically (and fortunately) separated from the tactile sensory information otherwise associated with explosions. However, it is contemplated that if the visual event of an explosion could be simultaneously displayed with a rush of heated air against the visual event viewer, the realism of the explosive visual event would be enhanced. It is with this notion in mind that the present invention has been devised.

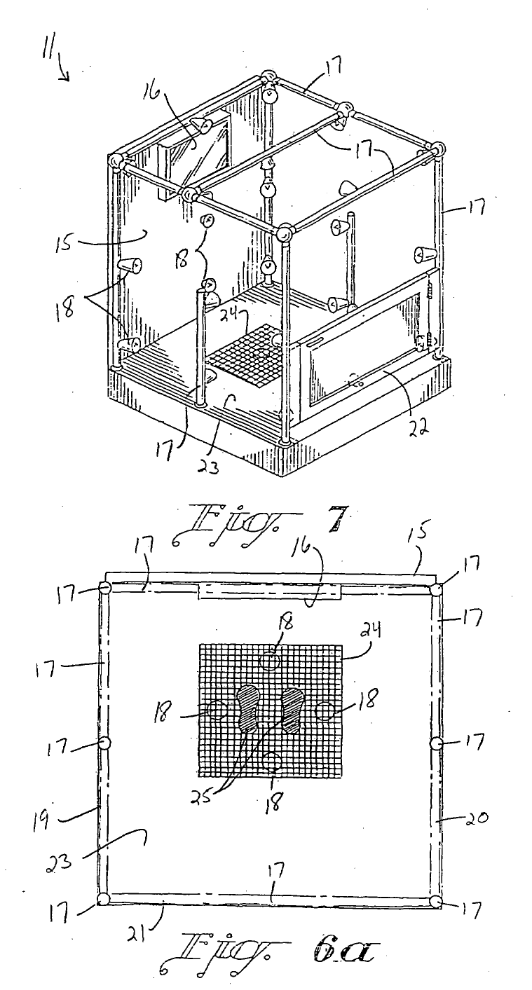

Thus, the present invention discloses a sensory enhancement method and system for visual media 10 as generally referenced in FIG. 14. Sensory enhancement method and system for visual media 10 is designed to preferably provide a visual event viewer or other user with additional sensory information otherwise inherently associated with visual events displayed upon a view screen. In this regard, sensory enhancement method and system for visual media 10 preferably comprises, in combination, a sensory-information-delivery chamber 11 as illustrated and referenced in FIGS. 7, 8, and 14; forced air means 12 as schematically referenced in FIG. 14; compressed air means 13 as schematically referenced in FIG. 14; and central processing means 14 or computer means as schematically referenced in FIG. 14.

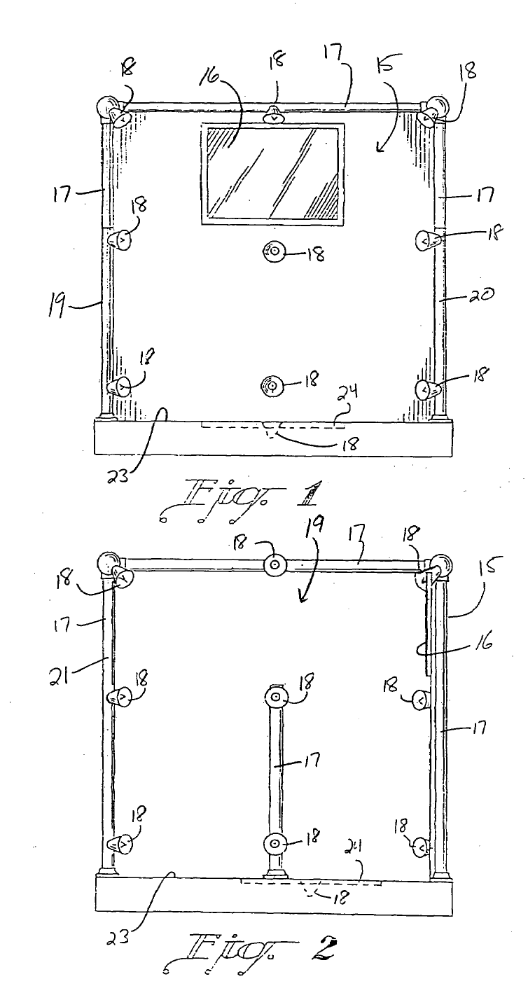

Sensory-information-delivery chamber 11 preferably comprises a substantially cubic framework as may be seen from a general inspection of FIGS. 7, 8, and 14. FIGS. 1-6(a) depict the preferably cubic framework from a variety of different plan views to aid the reader in his or her understanding of the preferred embodiment of the present invention. FIG. 1, for example, is a plan view of the forward wall (or one vertical wall or region) of the cubic frame as seen from a visual event viewer positioned inside the cubic framework with certain parts removed so as to draw the reader's attention to the substantially rectangular (preferably square) forward wall. It will be seen from an inspection of FIG. 1 that the forward wall essentially comprises a view wall 15 as illustrated and referenced in FIGS. 1, 2, 3, 5, 6, 6(a), 7, 8, 14, and 15. Sensory-information-delivery chamber 11, being preferably cubic or parallelepiped in configuration, thus inherently comprises eight corner regions. It will be further understood that the eight corner regions of the presently described sensory-information-delivery chamber 11 thus include four superior corners and four inferior corners.

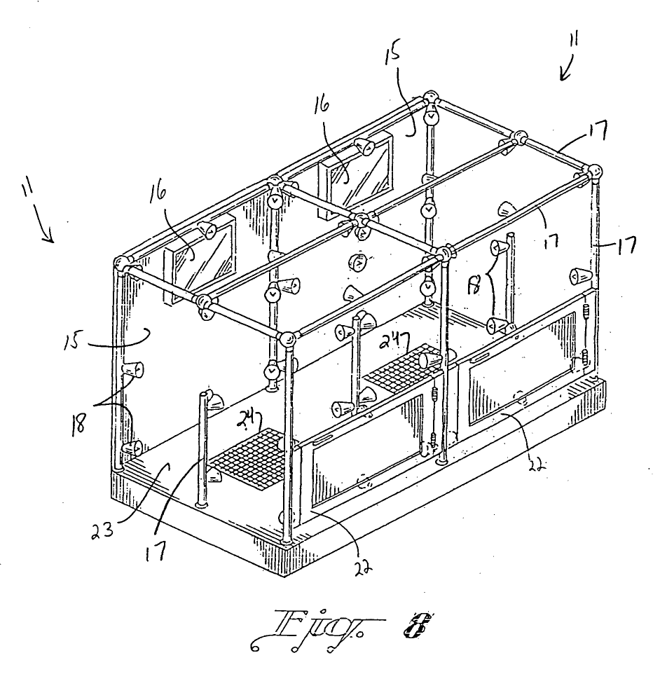

It will be seen from an inspection of the noted figures that view wall 15 preferably comprises visual image display means or a view screen 16. Further structures illustrated in FIG. 1 include ductwork or air ducts 17 (which comprise a portion of the cubic framework) and a plurality of vent assemblies 18. Air ducts 17 are further illustrated and referenced in FIGS. 1-10, 13(a)-13(d), 14, and 15. Vent assemblies 18 are further illustrated and referenced in FIGS. 1-11, 14, and 15. It will be seen from an inspection of FIGS. 9 and 10, in particular, that air ducts 17 preferably comprise a plurality of forced-air passageways as referenced at 29 and a plurality of compressed-air hoses 30, the forced-air passageways 29 housing the compressed-air hoses 30. It is contemplated that air ducts 17 are preferably constructed from tubular conduit, such as PVC conduit, so as to simultaneously provide the cubic framework with sturdy support structure (to maintain the cubic framework) as well as to provide air passageways. Forced-air passageways 29 interconnect each vent assembly 18 with the forced air means and compressed-air hoses 30 interconnect each vent assembly 18 with the compressed air means, which forced air means and compressed air means are described in more detail hereinafter.

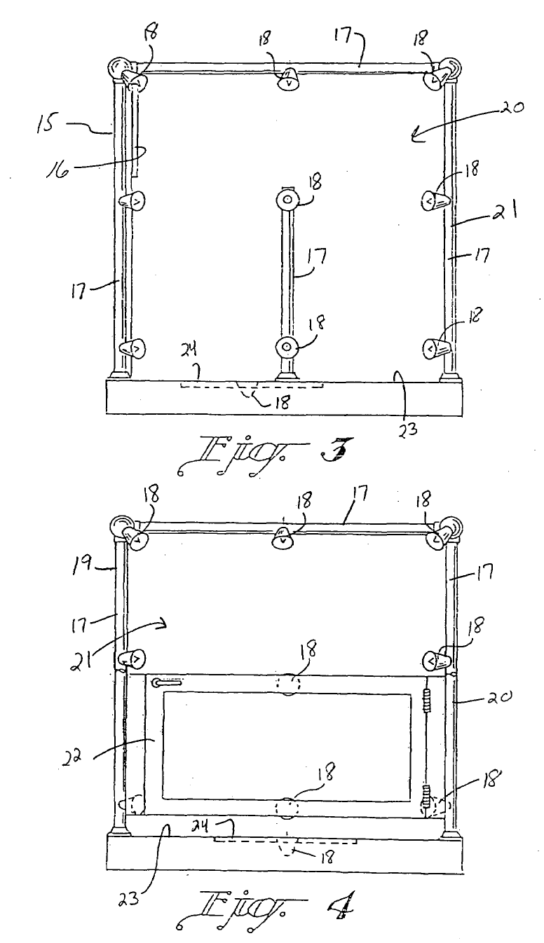

FIG. 2 is a plan view of the left vertical region 19 or left vertical wall of the cubic framework showing a right edge view of view screen 16. Left vertical region 19 is further illustrated and referenced in FIGS. 1, 4, 5, 6, 6(a), and 15. FIG. 3 is a plan view of the right vertical region 20 or right vertical wall showing a left edge view of view screen 16. Right vertical region 20 is further illustrated and referenced in FIGS. 1, 4, 5, 6, 6(a), and 15. FIG. 4 is a plan view of the rearward vertical region 21 or rear vertical wall showing an optional rear-mounted door 22 or inlet/out means. Rearward vertical region 21 is further illustrated and referenced in FIGS. 2, 3, 5, 6, and 6(a). Rear-mounted door 22 is further illustrated and referenced in FIGS. 7, 8, and 14.

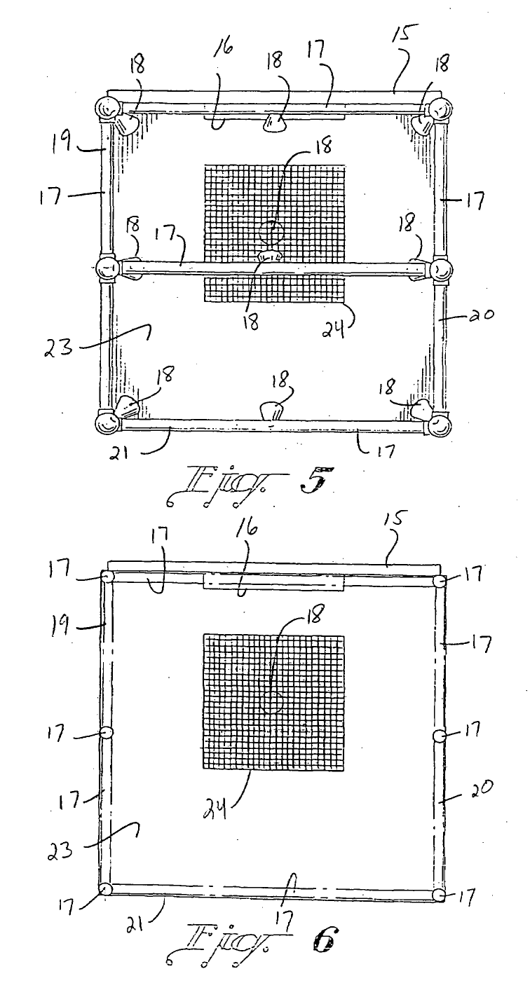

FIG. 5 is a top plan view of sensory-information-delivery chamber 11 showing the top edge view of view screen 16, certain ductwork or air ducts 17, a viewer support platform 23, and a plurality of vent assemblies 18. Viewer support platform 23 is further illustrated and referenced in FIGS. 1-8, 14, and 15. FIG. 6 is a top plan view of viewer support platform 23 showing an optional view region support grid 24, a single vent assembly 18 (as mounted under optional view region support grid 24), and the top edge view of view screen 16. View region support grid 24 is further illustrated and referenced in FIGS. 1-8, 14, and 15. FIG. 6(a) is a top plan view of an alternative embodiment of viewer support platform 23 showing view region support grid 24 with optional foot print indicia 25. It is contemplated that foot print indicia 25 function to provide the visual event viewer with view region alignment means for more accurately placing or positioning the visual event viewer in the viewer-locating region. In other words, it is contemplated that a visual event viewer or user of the present invention may more properly position himself or herself within sensory-information-delivery chamber 11 for receiving coordinated visual-tactile sensations by standing upon foot print indicia 25.

It will be seen from a comparative inspection of FIGS. 1-8 that view region support grid is substantially centrally located relative to the inferior corners of sensory-information-delivery chamber 11. However, in the preferred embodiment, it is contemplated that view region support grid 24 is positioned within viewer support platform 23 such that view region support grid 24 is shifted slightly forward of center or slightly toward view wall 15. In other words, from an inspection of FIGS. 1, 4, 5, 6, and 6(a), it will be seen that view region support grid 24 is substantially centered from left to right. However, from an inspection of FIGS. 2, 3, 5, 6, and 6(a), it will be seen that view region support grid 24 is shifted slightly forward of center from extreme fore to aft positions. The view region support grid 24 essentially defines the viewer-locating region, which region is essentially defined by the areas in superior adjacency to view region support grid 24 extending from viewer support platform 23 to the superior most region of sensory-information-delivery chamber 11.

Viewer support platform 23 is designed to support a visual event viewer (e.g.: a movie watcher or a video game player). The visual event viewer is preferably positioned in the viewer-locating region. As earlier specified, the viewer-locating region is essentially that region within sensory-information-delivery chamber 11 above view region support grid 24. The viewer-locating region may be more properly specified by a substantially uniform radial distance extending from the intersection of two vertically-oriented planes diagonally extending through opposite corner regions. It will be noted that the intersection of two planes is a line or axis and that the intersection of two vertical planes is a vertically-oriented line or axis. A substantially uniform radial distance extending from a vertically-oriented line or axis is a vertically-oriented cylinder, the diameter of which is twice that of the substantially uniform radial distance. In the preferred embodiment, the viewer-locating region may be defined by a radial distance that is approximately half the maximum width (or diameter) of a human being, the general shape of a view screen of visual event viewer being roughly approximate to (or containable within) a cylindrical shape. It is contemplated that the diameter of the heretofore described cylinder is substantially equal in magnitude to the length of one side of view region support grid 24. It will thus be understood that the viewer-locating region is preferably intermediate or centrally located relative to the corner regions of the cubic framework.

Each vent assembly 18 is preferably conical in overall shape as has been repeatedly illustrated throughout the drawing figures. In this regard, it will be understood that each vent assembly thus has a vent axis longitudinally extending through the center thereof. Each vent axis is thus designed to extend through the viewer-locating region. In other words, each vent assembly 18 is aimed toward the viewer-locating region so as to more properly direct moving air toward the visual event viewer.

It will be understood from an inspection of the noted figures that sensory-information-delivery chamber 11 preferably comprises a plurality of vent assemblies 18 mounted in or adjacent the corners or corner regions of the chamber. These vent assemblies may collectively be referred to as corner vent assemblies. Intermediate the corner vent assemblies are positioned at least one vent assembly 18, which assemblies are mounted intermediate the corner regions of the chamber and are thus collectively referred to as intermediary vent assemblies.

The cubic framework, being of a substantially parallelepiped configuration, is substantially defined by the intersection of six planes, the intersecting planes being substantially orthogonal to one another. The cubic framework preferably comprises a series of interconnected air ducts 17 as previously noted. It will be seen or understood from an inspection of the noted figures that air ducts 17 preferably interconnect the corner regions as generally illustrated at ball joint structure(s) in the noted figures. The corner-mounted or corner vent assemblies 18 are preferably operably connected to air ducts 17 at the corner regions and the intermediary vent assemblies 18 are preferably operably connected to air ducts 17 intermediate the corner regions. It will be seen from an inspection of the noted figures that in the preferred embodiment, there is one intermediary vent assembly 18 spatially located substantially equidistant from the corner regions intermediate the corner vent assemblies.

As earlier specified, the cubic framework may be defined by the intersection of six planes. Preferably, each plane of sensory-information-delivery chamber 11 comprises nine vent assemblies or has nine vent assemblies cooperatively associated therewith. Thus, it will be understood that sensory-information-delivery chamber 11 preferably comprises twenty-six vent assemblies spatially located substantially as illustrated in FIG. 7. The central processing means selectively actuates at least one select vent assembly as per the requirements of the present invention. The select vent assembly is preferably chosen from the group consisting of the twenty-six vent assemblies. Notably, the vent assembly 18 cooperatively associated with the view region support grid is positioned beneath the grating or grid, which grid allows moving air to pass therethrough.

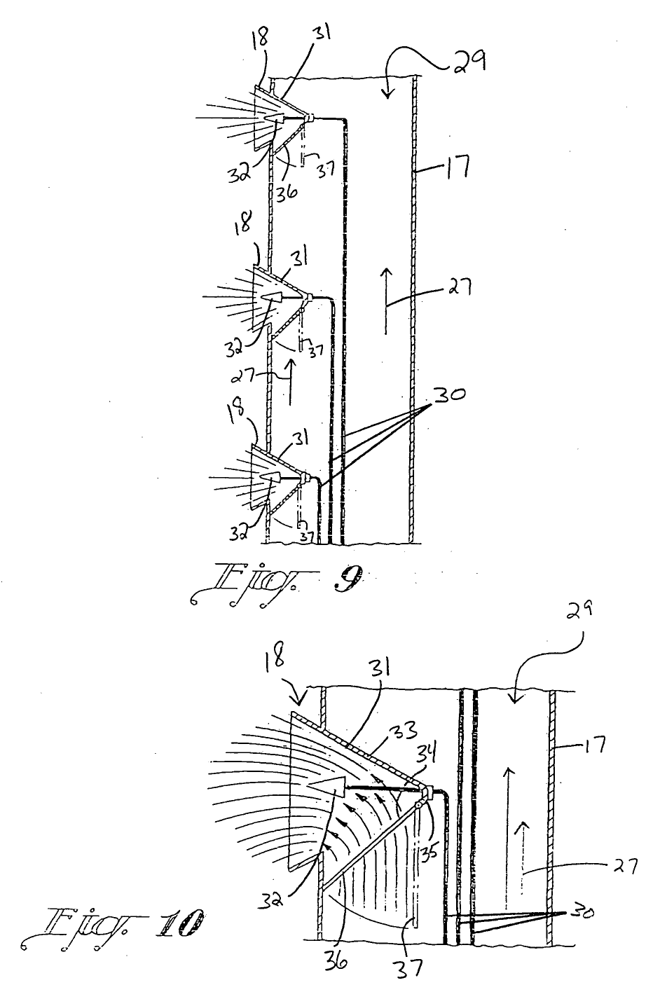

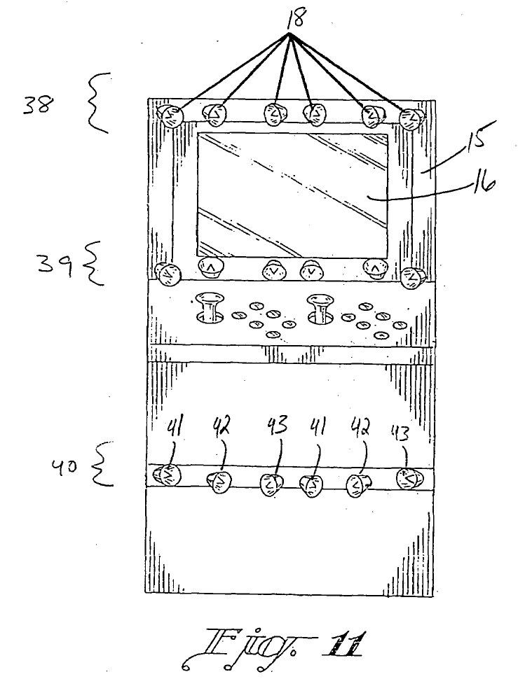

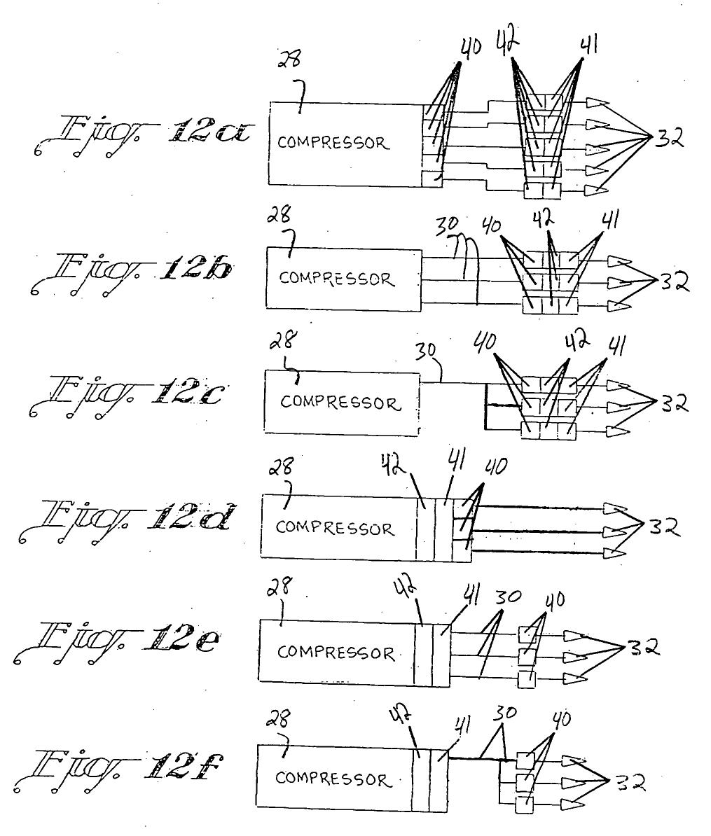

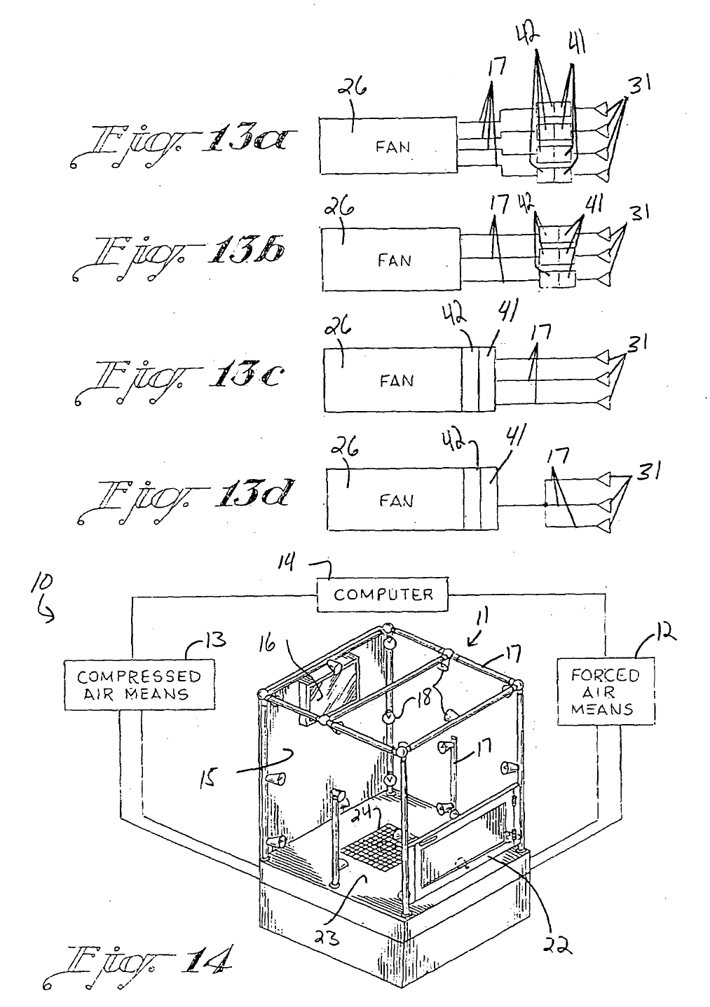

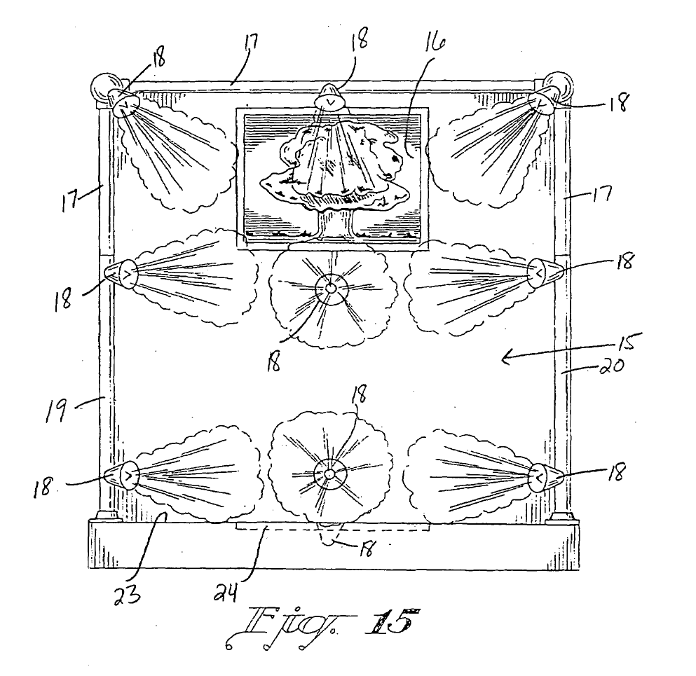

Each vent assembly preferably comprises a substantially conical outer vent shell 31 and a centrally-located inner vent nozzle 32 both as illustrated and referenced in FIGS. 9 and 10. Outer vent shells 31 are further referenced schematically in FIGS. 13(a)-13(d). Inner vent nozzles are further referenced schematically in FIGS. 12(a)-12(f). Each outer vent shell 31 preferably comprises a fixed upper air diversion portion 33 as illustrated and referenced in FIG. 10; a movable lower air diversion portion 34 as illustrated and referenced in FIG. 10; a vertex region 35 as illustrated and referenced in FIG. 10; and gate-operating means (not specifically illustrated). The gate-operating means are preferably located at vertex region 35 and are operably connected to the central processing means (via electronic circuitry not specifically illustrated) and lower air diversion portion 34. The central processing means are designed to selectively direct the gate-operating means to hingedly move lower air diversion portion 34 from a fully closed state (as referenced at 36 in FIGS. 9 and 10) to a fully open state (as referenced at 37 in FIGS. 9 and 10) for diverting select amounts of forced air against upper air diversion portion 33. Upper air diversion portion 33 is designed to direct forced air (as referenced at 27) toward the viewer-locating region.

Compressed-air hoses 30 preferably terminate at centrally-located inner vent nozzles 32. Inner vent nozzles 32 preferably each comprise valve means. The valve means are operably connected to the central processing means (via electronic circuitry not specifically illustrated) for selectively operating the valve means between a fully closed state and a fully open state for diverting select amounts of compressed air toward the viewer-locating region.

The corner vent assemblies 18 and the intermediary vent assemblies 18 each preferably comprise forced air outlet means and compressed air outlet means, each of the air outlet means being designed to direct moving air (as generated by the forced air means and compressed air means) toward the viewer-locating region for providing the visual event viewer with tactile sensory information, the tactile sensory information (arising or being provided to the user from sensory receptors and pathways between the receptors and certain areas of the brain) generated from collision(s) of moving air currents against the skin (or clothing contacting the skin).

The forced air means may preferably be defined by typical ventilation means such as may be embodied in a fan 26 or similar other blower mechanism as generally referenced schematically in FIGS. 13(a)-13(d). The fan or blower mechanism generates forced air currents and is thus operably connected to air ducts 17 for channeling the forced air currents through air ducts 17. The forced air currents have been generically referenced at 27 in FIGS. 9 and 10. The forced air means, as preferably defined by a fan or blower mechanism, is designed to selectively direct (via the central processing means or computer means) forced air or forced air currents through air ducts 17 and the forced air outlet means.

The compressed air means may preferably be defined by typical air compression means such as may be embodied in an air compressor unit 28 as generally referenced schematically in FIGS. 12(a) through 12(f). The compressed air means or air compression unit places air under pressure for pressurized release (or bursts) of air through compressed air outlet means for delivering relatively more forceful air currents (moving air) against the visual event viewer's skin or clothing for effecting relatively forceful tactile sensations. The compressed air means is preferably operably connected to air ducts 17 for selectively directing (as governed by the central processing means or computer means) compressed air through air ducts 17 and the compressed air outlet means.

The reader will recall that FIGS. 12(a)-12(f) show various schematic depictions of compressed air means. In this regard, FIG. 12(a) is a first schematic depiction of the compressed air means, showing a compressor, compressed air lines, and a plurality of compressed air outlet nozzles; FIG. 12(b) is a second schematic depiction of the compressed air means, showing a compressor, compressed air lines, and a plurality of compressed air outlet nozzles, etc. The preferred assembly of the compressor, air line and air outlet nozzle assemblies is schematically represented in FIGS. 12(e) and 12(f). From an inspection of these figures it will be seen that valve means as referenced at 40 are juxtaposed immediately adjacent the air outlet nozzles or inner vent nozzles 32, whereas in FIG. 12(a)-12(d), the valve means 40 are physically separated from inner vent nozzles 32.

The central processing means, as preferably defined by a computer, or computer-like machinery, is capable of reading and displaying video data, audio data, and further capable of reading and implementing software for selectively actuating or directing the forced air means and compressed air means. Thus, the central processing means is preferably operably connected to the visual image display means, the forced air means, and the compressed air means for selectively displaying the visual events (reading and displaying the video data) and for selectively actuating (by reading and implementing forced air and/or compressed air actuating software code) the forced air means and compressed air means to direct moving air (either forced air or compressed air) toward the viewer-locating region in simultaneous occurrence with the display of the visual events for delivering a coordinated visual-tactile sensation. In other words, it is contemplated that data may be placed into the data reading machinery, such as a computer, for reading and implementing a number of functions, including displaying video data and operating air moving machinery to direct moving air against the visual event viewer's skin in simultaneous occurrence with the visual event of interest. The coordinated visual-tactile sensation experience thus provides the visual event viewer with additional sensory information otherwise inherently associated with the visual events.

It will be further understood that viewer support platform 23 extends in a plane intermediate the four inferior corners and that view wall 15 extends in a plane (substantially orthogonal to the viewer support platform plane) intermediate two superior corners and two inferior corners. As earlier specified, view wall 15 preferably comprises visual image display means, preferably defined by view screen 16. As is common in the art, the visual image display means (or view screen 16) is designed to display visual images to a visual event viewer. It will be noted that not all visual imagery comprises visual events inherently associated with air movement. For example, color change, in and of itself, is electromagnetic energy and does not does not require a medium for movement (as would sound waves, for example). Thus, it is here noted that the visual images displayed by the visual image display means preferably comprise visual events inherently associated with air movement or otherwise propelled air, such as an explosion (as generally depicted in FIG. 16) or vehicular movement (as for example, in a driving game).

Notably, sensory information otherwise inherently associated with visual events may be characterized by heated or cooled air currents. For example, an explosion (e.g. a video game based visual event or a motion picture based visual event) may comprise heated air currents whereas downhill skiing or vehicular movement (e.g. a video game based visual event) may comprise cooled air currents. Thus, it is contemplated that screen enhancement system 10 may preferably comprise forced air means and compressed air means both of which further preferably comprise air heating-cooling means for selectively heating-cooling the moving air otherwise directed toward the viewer-locating region.

Thus, it is contemplated that the air heating-cooling means is designed to form a heated-cooled, visual-tactile sensation to enhance the realism of the visual event as experience both visually and tactilely. The air heating function of the air heating-cooling means may preferably be defined by typical air heating means such as may be embodied in a furnace or heater type mechanism (for heated forced air currents). It is contemplated that the means for heating compressed air currents may be achieved by heating compressed air lines or hoses interconnecting the compressed air means to the compressed air outlet means, which means are described in more detail hereinafter. Alternatively, the air cooling function of the air heating-cooling means may preferably be defined by typical air cooling or air-conditioning means such as may be embodied in an air conditioner or similar other type mechanism (for cooled forced air currents). It is further contemplated that the means for cooling compressed air currents may be achieved by chilling or cooling compressed air lines or hoses. Air heating means 41 and air cooling means 42 (collectively referred to herein as air heating-cooling means) have been schematically referenced in FIGS. 12(a)-12(f) and 13(a)-13(d).

The sensory enhancement method and system for visual media 10 has been illustrated throughout the present disclosure with certain enclosure structure eliminated for ease of illustration and understanding of the essential features of the present disclosure. It should be noted in this regard that sensory-information-delivery chamber 11 may be comprised of at least one select enclosure structure for structurally closing open space intermediate adjacent corner regions. In other words, it is contemplated that sensory-information-delivery chamber 11 may comprise solid wall, ceiling, and/or floor structure for otherwise enclosing open space intermediate adjacent corner regions. Thus, it is contemplated that the select enclosure structure may preferably be chosen from the group consisting of at least one enclosing wall, an enclosing ceiling, and an enclosing floor. Further, in this last regard, it is contemplated that, in order to allow viewers to gain access to/or allow viewers exit means from the sensory-information-delivery chamber 11, at least one enclosing wall preferably comprise viewer inlet/outlet means. The contemplated viewer inlet/outlet means thus enables a visual event viewer to selectively enter/exit the sensory-information-delivery chamber 11. Preferably, the viewer inlet/outlet means may be defined by rear-mounted door 22 as earlier described.

### Alternative Embodiment No. 1

The first alternative embodiment of the present invention concerns a sensory enhancement method and system for visual media substantially identical to the preferred embodiment of the present invention save for the fact that the first alternative embodiment concerns a sensory enhancement method and system for visual media comprising two sensory-information-delivery chambers 11, the sensory-information-delivery chambers 11 being arranged in side-by-side relation such that two superior corners and two inferior corners are shared by each sensory-information-delivery chamber 11. The first alternative embodiment of the present invention is generally illustrated in FIG. 8. It will be understood that the first alternative embodiment comprises a common plane between the two sensory-information-delivery chambers 11 for separating two viewer-locating regions and for distinguishing between two different target zones for directed air movement or otherwise propelled air currents substantially as earlier described. It is contemplated that two visual event viewers may wish to view visual events simultaneously (e.g.: by competing in a video game type scenario). It is with this foreseeable scenario in mind that the first alternative embodiment has been proposed and disclosed.

### Alternative Embodiment No. 2

The second alternative embodiment of the present invention concerns a sensory enhancement method and system for visual media markedly different from the preferred embodiment of the present invention insofar as the second alternative embodiment eliminates the cubic framework structure. Alternatively, the second alternative embodiment concerns a sensory-information-delivery structure such as has been generally illustrated in FIG. 11, for example. The sensory-information-delivery structure thus preferably comprises duct means, vent means, and a substantially planar view wall 15 substantially as earlier described. The sensory-information-delivery structure alternatively comprises four corner regions, the four corner regions including two superior corners and two inferior corners. As before, the duct means interconnect the corner regions and the vent means operably connect the duct means at the corner regions and at least one location intermediate the corner regions. The view wall 15 extends intermediate the superior corners and the inferior corners and comprises visual image display means (or view screen 16) for displaying visual images to a visual event viewer.

As earlier described, the visual images comprise visual events inherently associated with air movement or air currents. The visual event viewer typically positions himself or herself in a viewer-locating region adjacent view screen 16. Notably, the viewer-locating region is spatially located intermediate the corner regions. The vent means comprise air outlet means, the air outlet means for directing moving air toward the viewer-locating region and thus against the visual event viewer.

As earlier described, the central processing means are operably connected to the visual image display means, and air propulsion means (e.g.: forced air means and compressed air means). The central processing means functions to selectively display (as dictated by software type instructions given to the central processing means) the visual events and to selectively direct the forced air means and compressed air means to direct air toward the viewer-locating region in simultaneous occurrence with the display of the visual events for delivering a coordinated visual-tactile sensation. The coordinated visual-tactile sensation thus provides the visual image viewer with sensory information otherwise inherently associated with the visual events.

While the above description contains much specificity, this specificity should not be construed as limitations on the scope of the invention, but rather as an exemplification of the invention. For example, the sensory enhancement method and system for visual media may function to deliver sensory information to visual event viewers other than coordinated visual-tactile sensations. In this regard, for example, it is contemplated that the sensory enhancement method and system for visual media may comprise audio-delivery means, the audio-delivery means being operably connected to the central processing means for selectively delivering auditory sensory information (the auditory sensory information being inherently associated with the visual events). Thus, the audio-delivery means is designed to form a coordinated visual-auditory sensation.

Further, it is contemplated that the forced air means and the compressed air means may be collectively defined by air propulsion means, the air propulsion means being operably connected to the duct means for selectively directing moving air through the duct means and the air outlet means. The view wall 15 may be defined by comprising a plurality of view wall vent regions, the view wall vent regions comprising a superior vent region 38, an intermediate vent region 39, and an inferior vent region 40 all as illustrated and referenced in FIG. 11 by way of example. Further, superior vent region 38, intermediate vent region 39, and inferior vent region 40 may each be further defined by comprising a left vent assembly 41, a medial vent assembly 42, and a right vent assembly 43 as further illustrated and referenced in FIG. 11. It will be seen from an inspection of FIG. 11, that a dual, side-by-side sensory-information-delivery structure is contemplated as falling within the scope of the present invention.

Accordingly, although the invention has been described by reference to a preferred embodiment, and two alternative embodiments, it is not intended that the novel assembly or apparatus be limited thereby, but that modifications thereof are intended to be included as falling within the broad scope and spirit of the foregoing disclosure, the following claims and the appended drawings.

I claim:

1. A visual image display enhancement system, the visual image display enhancement system for providing a visual event viewer with additional sensory information otherwise inherently associated with visual events displayed upon visual image display means, the visual image display enhancement system comprising, in combination:
a sensory-information-delivery chamber, the sensory-information-delivery chamber comprising a substantially cubic framework, a plurality of corner vent assemblies, a plurality of intermediary vent assemblies, a substantially planar viewer support platform, a substantially planar view wall, and a viewer-locating region, the sensory-information-delivery chamber thus comprising eight corner regions, the eight corner regions including four superior corners and four inferior corners, the framework comprising a series of interconnected air ducts, the air ducts interconnecting the corner regions, the corner vent assemblies being operably connected to the air ducts at the corner regions, the intermediary vent assemblies being operably connected to the air ducts intermediate the corner regions, the viewer support platform extending intermediate the inferior corners, the view wall extending intermediate two superior corners and two inferior corners, the view wall comprising visual image display means, the visual image display means for displaying visual images to a visual event viewer, the visual images comprising visual events inherently associated with air movement, the viewer support platform for supporting a visual event viewer, the visual event viewer being positioned in the viewer-locating region, the viewer-locating region being defined by a substantially uniform radial distance extending from the intersection of two vertically-oriented planes diagonally extending through opposite corner regions, the corner vent assemblies and the intermediary vent assemblies each comprising forced air outlet means and compressed air outlet means, the air outlet means for directing moving air toward the viewer-locating region for providing the visual event viewer with tactile sensory information;
forced air means, the forced air means being operably connected to the air ducts, the forced air means for selectively directing forced air through the air ducts and the forced air outlet means;
compressed air means, the compressed air means being operably connected to the air ducts, the compressed air means for selectively directing compressed air through the air ducts and the compressed air outlet means; and
central processing means, the central processing means being operably connected to the visual image display means, the forced air means, and the compressed air means, the central processing means for selectively displaying the visual events and for selectively directing the forced air means and compressed air means to direct air toward the viewer-locating region in simultaneous occurrence with the display of the visual events for delivering a coordinated visual-tactile sensation, the coordinated visual-tactile sensation thus providing the visual event viewer with additional sensory information otherwise inherently associated with the visual events.

2. The visual image display enhancement system of claim 1 wherein the forced air means and the compressed air means comprise air heating-cooling means, the air heating-cooling means for selectively heating-cooling air directed toward the viewer-locating region, the air heating-cooling means for forming a heated-cooled, visual-tactile sensation.

3. The visual image display enhancement system of claim 2 wherein the cubic framework is substantially defined by the intersection of six planes, the intersecting planes being substantially orthogonal to one another, each plane having nine vent assemblies cooperatively associated therewith, the sensory-information-delivery chamber thus comprising twenty-six vent assemblies.

4. The visual image display enhancement system of claim 3 wherein each vent assembly comprises a vent axis longitudinally extending through the center thereof, the vent axes extendable through the viewer-locating region.

5. The visual image display enhancement system of claim 4 wherein the air ducts comprise a plurality of forced-air passageways and a plurality of compressed-air hoses, the forced-air passageways housing the compressed-air hoses, the forced-air passageways interconnecting each vent assembly with the forced air means, the compressed-air hoses interconnecting each vent assembly with the compressed air means.

6. The visual image display enhancement system of claim 5 wherein the vent assemblies each comprise a substantially conical outer vent shell and a centrally-located inner vent nozzle, each outer vent shell comprising a fixed upper air diversion portion, a movable lower air diversion portion, a vertex region, and gate-operating means, the gate-operating means being located at the vertex region and operably connected to the central processing means and lower air diversion portion, the central processing means for selectively directing the gate-operating means to hingedly move the lower air diversion portion from a fully closed state to a fully open state for diverting select amounts of forced air against the upper air diversion portion, the upper air diversion portion for directing forced air toward the viewer-locating region, the compressed-air hoses terminating at the centrally-located inner vent nozzles, the centrally-located inner vent nozzles each comprising valve means, the valve means being operably connected to the central processing means, the central processing means for selectively operating the valve means between a fully closed state and a fully open state for diverting select amounts of compressed air toward the viewer-locating region.

7. The visual image display enhancement system of claim 6 wherein the central processing means selectively actuates at least one select vent assembly, the select vent assembly being chosen from the group consisting of the twenty-six vent assemblies.

8. The visual image display enhancement system of claim 1 wherein the sensory-information-delivery chamber comprises at least one select enclosure structure, the select enclosure structure for structurally closing open space intermediate adjacent corner regions, the select enclosure structure being chosen from the group consisting of at least one enclosing wall, an enclosing ceiling, and an enclosing floor.

9. The visual image display enhancement system of claim 8 wherein at least one enclosing wall comprises viewer inlet/outlet means, the viewer inlet/outlet means for enabling the visual event viewer to selectively enter/exit the sensory-information-delivery chamber.

10. The visual image display enhancement system of claim 1 wherein the viewer support platform comprises foot print indicia, the foot print indicia providing the visual event viewer with view region alignment means, the view region alignment means for positioning the visual event viewer in the viewer-locating region.

11. The visual image display enhancement system of claim 1 wherein the visual image display enhancement system comprises audio-delivery means, the audio-delivery means being operably connected to the central processing means, the central processing means for selectively delivering auditory sensory information, the auditory sensory information being inherently associated with the visual events, the audio-delivery means for forming a coordinated visual-auditory sensation.

12. A visual image display enhancement system, the visual image display enhancement system for providing at least one visual event viewer with additional sensory information otherwise inherently associated with visual events displayed upon visual image display means, the visual image display enhancement system comprising, in combination:
at least one sensory-information-delivery chamber, the sensory-information-delivery chamber comprising a substantially cubic framework, duct means, vent means, a substantially planar viewer support platform, and a substantially planar view wall, the sensory-information-delivery chamber thus comprising eight corner regions, the eight corner regions including four superior corners and four inferior corners, the duct means interconnecting the corner regions, the vent means operably connected to the duct means at the corner regions and at least one location intermediate the corner regions, the viewer support platform extending intermediate the inferior corners, the view wall extending intermediate two superior corners and two inferior corners, the view wall comprising visual image display means, the visual image display means for displaying visual images to a visual event viewer, the visual images comprising visual events inherently associated with air movement, the viewer support platform for supporting a visual event viewer, the visual event viewer being positioned in a viewer-locating region, the viewer-locating region being substantially centrally-located relative to the corner regions, the vent means comprising forced air outlet means and compressed air outlet means, the forced air outlet means and compressed air outlet means for directing moving air toward the viewer-locating region for providing the visual event viewer with tactile sensory information;
forced air means, the forced air means being operably connected to the duct means, the forced air means for selectively directing forced air through the duct means and the forced air outlet means;
compressed air means, the compressed air means being operably connected to the duct means, the compressed air means for selectively directing compressed air through the duct means and the compressed air outlet means; and
central processing means, the central processing means being operably connected to the visual image display means, the forced air means, and the compressed air means, the central processing means for selectively displaying the visual events and for selectively directing the forced air means and compressed air means to direct air toward the viewer-locating region in simultaneous occurrence with the display of the visual events for delivering a coordinated visual-tactile sensation, the coordinated visual-tactile sensation for providing the visual event viewer with sensory information otherwise inherently associated with the visual events.

13. The visual image display enhancement system of claim 12 wherein the forced air means and the compressed air means comprise air heating-cooling means, the air heating-cooling means for selectively heating-cooling air directed toward the viewer-locating region, the air heating-cooling means for forming a heated-cooled, visual-tactile sensation.

14. The visual image display enhancement system of claim 13 wherein the cubic framework is substantially defined by the intersection of six planes, the intersecting planes being substantially orthogonal to one another, each plane having nine vent assemblies cooperatively associated therewith, the sensory-information-delivery chamber thus comprising twenty-six vent assemblies.

15. The visual image display enhancement system of claim 14 wherein each vent assembly comprises a vent axis longitudinally extending through the center thereof, the vent axes extendable through the viewer-locating region.

16. The visual image display enhancement system of claim 15 wherein the duct means comprise a plurality of forced-air ducts and a plurality of compressed-air hoses, the forced-air ducts housing the compressed-air hoses, the forced-air ducts interconnecting each vent assembly with the forced air means, the compressed-air hoses interconnecting each vent assembly with the compressed air means.

17. The visual image display enhancement system of claim 16 wherein the vent assemblies each comprise a substantially conical outer vent shell and a centrally-located inner vent nozzle, each outer vent shell comprising a fixed upper air diversion portion, a movable lower air diversion portion, a vertex region, and gate-operating means, the gate-operating means being located at the vertex region and operably connected to the central processing means and lower air diversion portion, the central processing means for selectively directing the gate-operating means to hingedly move the lower air diversion portion from a fully closed state to a fully open state for diverting select amounts of forced air against the upper air diversion portion, the upper air diversion portion for directing forced air toward the viewer-locating region, the compressed-air hoses terminating at the centrally-located inner vent nozzles, the centrally-located inner vent nozzles each comprising valve means, the valve means being operably connected to the central processing means, the central processing means for selectively operating the valve means between a fully closed state and a fully open state for diverting select amounts of compressed air toward the viewer-locating region.

18. The visual image display enhancement system of claim 17 wherein the central processing means selectively actuates at least one select vent assembly, the select vent assembly being chosen from the group consisting of the twenty-six vent assemblies.

19. The visual image display enhancement system of claim 18 wherein the sensory-information-delivery chamber comprises at least one select enclosure structure, the select enclosure structure for structurally closing open space intermediate adjacent corner regions, the select enclosure structure being chosen from the group consisting of at least one enclosing wall, an enclosing ceiling, and an enclosing floor.

20. The visual image display enhancement system of claim 19 wherein at least one enclosing wall comprises viewer inlet/outlet means, the viewer inlet/outlet means for allowing the visual image viewer to selectively enter/exit the sensory-information-delivery chamber.

21. The visual image display enhancement system of claim 12 wherein the visual image display enhancement system comprises two sensory-information-delivery chambers, the sensory-information-delivery chambers being arranged in side-by-side relation such that two superior corners and two inferior corners are shared by each sensory-information-delivery chamber.

22. The visual image display enhancement system of claim 12 wherein the viewer support platform comprises foot print indicia, the foot print indicia providing the visual event viewer with view region alignment means, the view region alignment means for positioning the visual event viewer in the viewer-locating region.

23. The visual image display enhancement system of claim 12 wherein the visual image display enhancement system comprises audio-delivery means, the audio-delivery means being operably connected to the central processing means, the central processing means for selectively delivering auditory sensory information, the auditory sensory information being inherently associated with the visual events, the audio-delivery means for forming a coordinated visual-auditory sensation.

24. A visual image display enhancement system, the visual image display enhancement system for providing a visual event viewer user with additional sensory information otherwise inherently associated with visual events displayed upon visual image display means, the visual image display enhancement system comprising, in combination:
at least one sensory-information-delivery structure, the sensory-information-delivery structure comprising duct means, vent means, and a substantially planar view wall, the sensory-information-delivery structure comprising four corner regions, the four corner regions including two superior corners and two inferior corners, the duct means interconnecting the corner regions, the vent means operably connected to the duct means at the corner regions, the view wall extending intermediate the superior corners and the inferior corners, the view wall comprising visual image display means, the visual image display means for displaying visual images to a visual event viewer, the visual images comprising visual events inherently associated with air movement, the visual event viewer being positioned in a viewer-locating region, the viewer-locating region being intermediate the corner regions, the vent means comprising air outlet means, the air outlet means for directing moving air toward the viewer-locating region and thus against the visual event viewer;
air propulsion means, the air propulsion means being operably connected to the duct means, the air propulsion means for selectively directing propelled air through the duct means and the air outlet means;
central processing means, the central processing means being operably connected to the visual image display means and the air propulsion means, the central processing means for selectively displaying the visual events and for selectively directing the air propulsion means to direct propelled air toward the viewer-locating region in simultaneous occurrence with the display of the visual events for delivering a coordinated visual-tactile sensation, the coordinated visual-tactile sensation for providing the visual image viewer with sensory information otherwise inherently associated with the visual events.

25. The visual image display enhancement system of claim 24 wherein the air propulsion means comprises forced air means and compressed air means, the forced air means being operably connected to the duct means, the forced air means for selectively directly forced air through the duct means and air outlet means, the compressed air means being operably connected to the duct means, the compressed air means for selectively directing compressed air through the duct means and the air outlet means.

26. The visual image display enhancement system of claim 25 wherein the forced air means and the compressed air means comprise air heating-cooling means, the air heating-cooling means for selectively heating-cooling air directed toward the viewer-locating region, the air heating-cooling means for forming a heated-cooled, visual-tactile sensation.

27. The visual image display enhancement system of claim 24 wherein the visual image display enhancement system comprises audio-delivery means, the audio-delivery means being operably connected to the central processing means, the central processing means for selectively delivering auditory sensory information, the auditory sensory information being inherently associated with the visual events, the audio-delivery means for forming a coordinated visual-auditory sensation.

28. The visual image display enhancement system of claim 24 wherein the view wall comprises a plurality of view wall vent regions, the view wall vent regions comprising a superior vent region, an intermediate vent region, and an inferior vent region.

29. The visual image display enhancement system of claim 28 wherein the superior vent region, the intermediate vent region, and the inferior vent region each comprise a left vent assembly, a medial vent assembly, and a right vent assembly.

30. The visual image display enhancement system of claim 29 wherein each vent assembly comprises a vent axis longitudinally extending through the center thereof, the vent axes extendable through the viewer-locating region.

31. The visual image display enhancement system of claim 30 wherein the vent assemblies each comprise a substantially conical outer vent shell and a centrally-located inner vent nozzle, each outer vent shell comprising a fixed upper air diversion portion, a movable lower air diversion portion, a vertex region, and gate-operating means, the gate-operating means being located at the vertex region and operably connected to the central processing means and lower air diversion portion, the central processing means for selectively directing the gate-operating means to hingedly move the lower air diversion portion from a fully closed state to a fully open state for diverting select amounts of forced air against the upper air diversion portion, the upper air diversion portion for directing forced air toward the viewer-locating region, the compressed-air hoses terminating at the centrally-located inner vent nozzles, the centrally-located inner vent nozzles each comprising valve means, the valve means being operably connected to the central processing means, the central processing means for selectively operating the valve means between a fully closed state and a fully open state for diverting select amounts of compressed air toward the viewer-locating region.

32. The view enhancement system of claim 24 wherein the sensory-information-delivery structure comprises view region alignment means, the view region alignment means for positioning the visual event viewer in the viewer-locating region,

33. The visual image display enhancement system of claim 24 wherein the duct means comprise a plurality of forced-air ducts and a plurality of compressed-air hoses, the forced-air ducts housing the compressed-air hoses, the forced-air ducts interconnecting each vent assembly with the forced air means, the compressed-air hoses interconnecting each vent assembly with the compressed air means.

34. The visual image display enhancement system of claim 24 wherein the sensory-information-delivery structure comprises at least one select enclosure structure, the select enclosure structure for structurally closing open space intermediate adjacent corner regions, the select enclosure structure being chosen from the group consisting of at least one enclosing wall, an enclosing ceiling, and an enclosing floor.

35. The visual image display enhancement system of claim 34 wherein at least one enclosing wall comprises viewer inlet/outlet means, the viewer inlet/outlet means for allowing the visual image viewer to selectively enter/exit the sensory-information-delivery structure.

36. The visual image display enhancement system of claim 24 wherein the visual image display enhancement system comprises two sensory-information-delivery structures, the sensory-information-delivery structures being arranged in side-by-side relation such that two superior corners and two inferior corners are shared by each sensory-information-delivery structure.
